(19) United States
(12) Patent Application Publication
(10) Pub. No.: US 2025/0300413 A1
(43) Pub. Date: Sep. 25, 2025

(54) SYSTEM AND METHOD FOR TERMINATING AN ETHERNET CABLE

(71) Applicant: Siemens Energy Limited, Newcastle Upon Tyne (GB)

(72) Inventors: Jordan Buchanan, Ulverston (GB); Daniel Walton, Carnforth (GB); Christopher Burrow, Ulverston (GB); Philip Keith, Grange-Over-Sands (GB)

(21) Appl. No.: 19/068,037

(22) Filed: Mar. 3, 2025

(30) Foreign Application Priority Data
Mar. 19, 2024 (GB) 2403924.0

(51) Int. Cl. H01R 24/86; H01R 9/11; H01R 13/52; H01R 13/627; H01R 107/00

(52) U.S. Cl. CPC H01R 24/86; H01R 9/11; H01R 13/5202; H01R 13/5213; H01R 13/6277; H01R 2107/00; H01R 2201/04

(57) ABSTRACT

A termination system includes an ethernet cable including eight conductors, a wire cage coupled to the ethernet cable and including eight arms arranged in a pattern, each arm including a first recess that extends to an end of the arm. Each conductor is associated with one of the arms and includes a portion positioned within the first recess. The termination also includes a connector having eight apertures arranged in the pattern, and eight contact sleeves, each disposed within one of the apertures and sized to receive one of the arms. The conductor associated with each arm is in electrical contact with the associated contact sleeve, and a termination cap is coupled to the cable.

### BACKGROUND

Ethernet cables are useful for the rapid transmission of large quantities of data. However, ethernet cable use in subsea or marine applications can be challenging due to the corrosive, high-pressure environment to which they might be exposed. To facilitate ethernet cable use in subsea applications, complicated and expensive terminations are required. These terminations require skill and special technical processes to manufacture and, due to the complexity, often require expensive testing and inspection prior to use.

### SUMMARY

In one aspect, a termination system includes a cable including a first quantity of conductors, a wire cage coupled to the cable and including a second quantity of arms arranged in a first pattern, the second quantity equal to the first quantity. Each arm includes a first recess that extends to an end of the arm. A portion of one of the first quantity of conductors is positioned within the first recess. A connector includes a third quantity of apertures is arranged in a second pattern that corresponds to the first pattern, each of a plurality of contact sleeves are disposed within one of the apertures and are sized to receive one of the arms. The conductor associated with the arm is in electrical contact with the contact sleeve, and a termination cap is coupled to the cable.

The termination system may also include a cable that is an ethernet cable and where the first quantity, the second quantity, and the third quantity each equal eight.

The termination system may also include arms that each include a latch member that engages the associated contact sleeve to retain the arm within the contact sleeve.

The termination system may also include arms where each arm includes a second recess opposite the first recess, and where a portion of the conductor is disposed within each of the first recess and the second recess.

The termination system may also include a termination boot positioned to cover the termination cap and form a high-pressure seal therebetween.

The termination system may also include connectors that each include an annular outer wall, an where a compression ring is positioned between the termination cap and the outer wall, the compression ring compressing the termination boot against the outer wall and the termination cap.

The termination system may also include where each of the arms extends parallel to a long axis of the wire cage.

The termination system may also include where each contact sleeve includes a reduced diameter portion arranged to engage the portion of the conductor in each of the first recess and the second recess.

In another aspect, a termination system includes an ethernet cable including eight conductors, a wire cage coupled to the ethernet cable and including eight arms arranged in a pattern, each arm including a first recess that extends to an end of the arm. Each conductor is associated with one of the arms and includes a portion positioned within the first recess. The termination also includes a connector having eight apertures arranged in the pattern, and eight contact sleeves, each disposed within one of the apertures and sized to receive one of the arms. The conductor associated with each arm is in electrical contact with the associated contact sleeve, and a termination cap is coupled to the cable.

The termination system may also include a cable that is an ethernet cable and where the first quantity, the second quantity, and the third quantity each equal eight.

The termination system may also include arms that each includes a latch member that engages the associated contact sleeve to retain each arm within the contact sleeve.

The termination system may also include warms that each includes a second recess opposite the first recess, and where a portion of the conductor is disposed within each of the first recess and the second recess.

The termination system may also include a termination boot positioned to cover the termination cap and form a high-pressure seal therebetween.

The termination system may also include a connector that includes an annular outer wall, and where a compression ring is positioned between the termination cap and the outer wall, the compression ring compressing the termination boot against the outer wall and the termination cap.

The termination system may also include arms that each extend parallel to a longitudinal axis of the wire cage.

The termination system may also include a contact sleeve that includes a reduced diameter portion arranged to engage the portion of the conductor in each of the first recess and the second recess.

In yet another aspect, a method of terminating an ethernet cable includes connecting a wire cage to the ethernet cable, the wire cage including eight arms that extend parallel to one another along a long axis, and extending each of eight conductors along one and only one of the arms in a direction parallel to the long axis along a first side and a second side opposite the first side. The method further includes positioning each of eight contact sleeves in an aperture formed in a connector, inserting each of the arms into one of the contact sleeves such that the corresponding conductor of each arm forms an electrical connection with the corresponding contact sleeve, and positioning a termination cap partially within the connector to cover the wire cage.

The method may also include forming a first recess on the first side of each arm and a second recess on the second side of each arm.

The method may also include positioning a termination boot to cover the termination cap and form a high-pressure seal therebetween.

The method may also include inserting a compression ring between the termination cap and an outer wall of the connector, and compressing the termination boot against the outer wall and the termination cap.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates a portion of a termination of an ethernet cable including a stuffing sleeve and a wire cage.

FIG. 2 illustrates the portion of the termination of FIG. 1 prior to insertion into a connector.

FIG. 3 illustrates the portion of the termination of FIG. 1 after insertion into the connector of FIG. 2.

FIG. 4 is a cross-sectional view of a portion of the termination as illustrated in FIG. 3 taken along a centerline of one of the arms.

FIG. 5 is a cross-sectional view of a portion of the termination as illustrated in FIG. 3 taken along a centerline of one of the arms.

FIG. 6 illustrates the termination as illustrated in FIG. 3 with the addition of a support wedge.

FIG. 7 illustrates the termination as illustrated in FIG. 6 and including the addition of a termination cap.

FIG. 8 illustrates the termination as illustrated in FIG. 7 and including the addition of a termination boot.

FIG. 9 is a cross-sectional view of the termination of FIG. 8 and including the addition of a compression ring 902 taken along a long axis of the wire cage.

FIG. 10 is a cross-sectional view of the termination of FIG. 8 and including the addition of a compression ring 902 taken along a long axis of the wire cage.

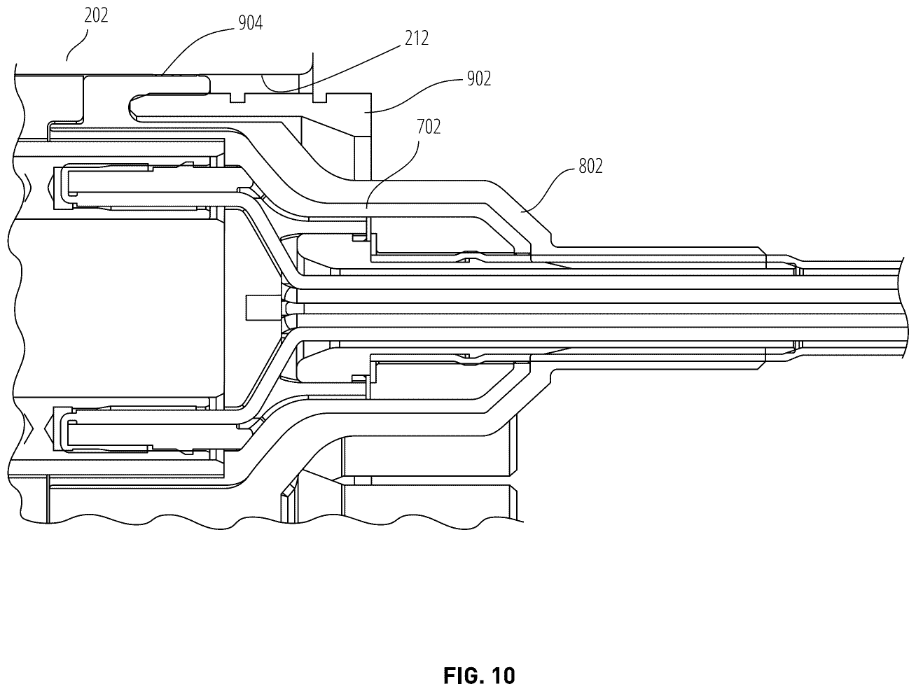

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

It should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, terms such as “first”, “second”, “third” and so forth may be used herein to refer to various elements, information, functions, or acts, but should not be considered as limiting in any way. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with the further portion unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

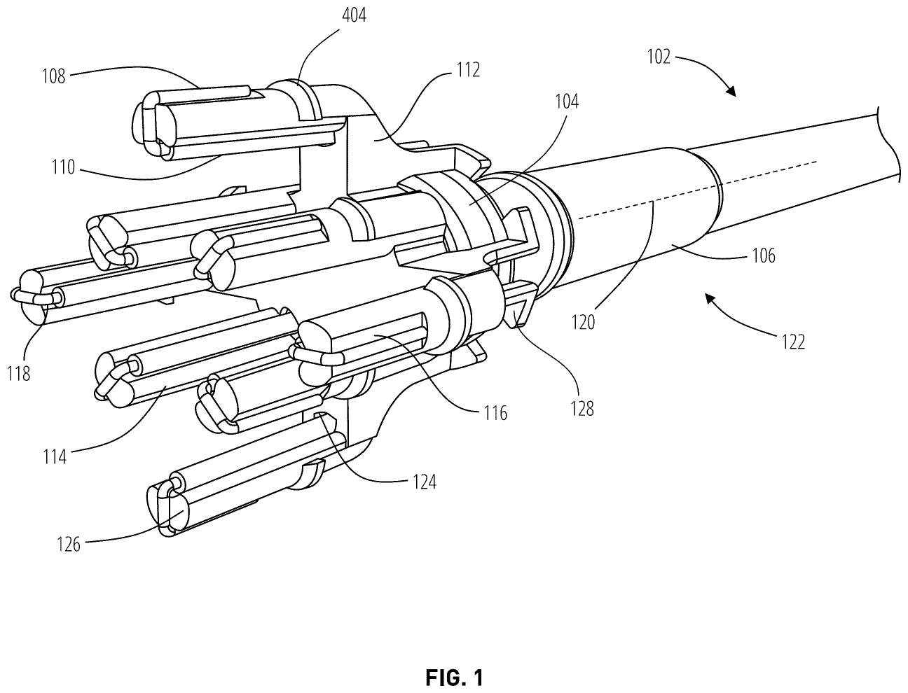

Cables 102 as described herein include one or more conductors 108 surrounded by a cable cover 106 that protects the conductors 108 from the environment (e.g., electromagnetic shielding, corrosion protection, thermal protection, etc.) or from physical damage. While the cable 102 could be any type of cable 102 including a data cable 102 a power cable 102 or a combination of the two, FIG. 1 illustrates a cable 102 in the form of an ethernet cable 122.

Ethernet cables 122 include eight color-coded conductors 108. The conductors 108 are twisted into four pairs of two conductors 108 for a Gigabit Ethernet connection, and two pairs of four conductors 108 for 10/100 Ethernet connections. Typically, CAT6, CAT7, and CAT8 ethernet cables 122 operate as gigabit ethernet connections. However, the actual type of cable 102 is not critical to the arrangement illustrated herein.

In order to connect the cable 102 to another device, the end of the cable 102 must be terminated. Termination includes attaching one or more components to the cable 102 to support the various conductors 108 in a desired manner to facilitate the connection.

To terminate the cable 102 of FIG. 1, a stuffing sleeve 104 is attached to the end of the cable 102. A portion of the stuffing sleeve 104 fits beneath the cable cover 106 such that the cable cover 106 acts to hold the stuffing sleeve 104 in place. In some constructions, other fastening means such as crimping, adhesives, and the like are used to enhance the connection between the cable 102 and the stuffing sleeve 104. The stuffing sleeve 104 provides a resilient surface to seal onto, such that it doesn't deform under pressure.

A wire cage 112 attaches to the stuffing sleeve 104 to provide a support mechanism for the conductors 108. In preferred constructions, the wire cage 112 includes a plurality of attachment legs 128 that engage the stuffing sleeve 104 to attach the wire cage 112 to the stuffing sleeve 104 without the need for any special tools or skills to make the attachment. In preferred constructions, the wire cage 112 is formed from a plastic material such as PEEK and the stuffing sleeve 104 is formed from a metallic material. However, the two components could be formed as a single piece from a single material if desired.

The wire cage 112 includes a number of arms 114 that extend parallel to a long axis 120 of the wire cage 112. The number of arms 114 generally corresponds to the number of conductors 108 within the cable 102. In the illustrated construction, eight arms 114 are provided with each arm 114 supporting one distinct conductor 108 from the cable 102. However, some constructions may use more or fewer arms 114 than conductors 108 as may be desired for the particular application.

Each conductor 108 passes through a portion of the wire cage 112 to an exit aperture 124 positioned adjacent one of the arms 114. A portion of the insulation 110 that covers and protects each wire is removed to expose the conductor 108.

A first recess 116 is formed on a first side of each of the arms 114 with a second recess 118 formed on the side of each arm 114 opposite the first recess 116. Each second recess 118 is positioned adjacent the exit aperture 124 to receive a portion of the associated conductor 108 that still includes its insulation 110. The conductor 108 extends around an arm end 126 and then the uninsulated portion of the conductor 108 extends down the first recess 116.

Each first recess 116 and second recess 118 may include a flat portion or a tapered portion. Tapered recesses 116, 118 could include V-shaped or U-shaped recesses 116, 118 that better restrain the conductor 108 in the desired position.

As one will note, the wire cage 112 is easily attached to the cable 102 without the need for any special tools or skills. In addition, each of the conductors 108 is positioned and exposed as needed to complete the termination without the need for special tools or skills.

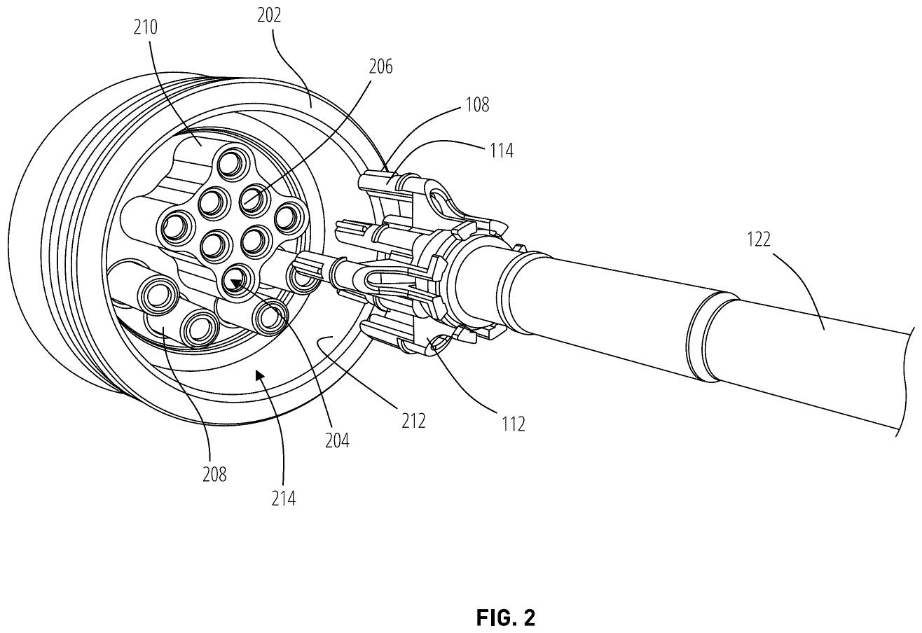

FIG. 2 illustrates the next step in the termination of the ethernet cable 122 in which the wire cage 112 is received within a connector 202. The connector 202 includes an outer wall 212 that defines a recessed space 214 therein. In the illustrated construction, the outer wall 212 is annular with other shapes and arrangements being possible.

An ethernet base 210 extends from the connector 202 within the recessed space 214 and defines eight apertures 204. The apertures 204 are arranged in a pattern that corresponds to the pattern of the arms 114. Any pattern could be employed so long as the pattern of the arms 114 matches the pattern of the apertures 204. The illustrated orthogonal pattern of the illustrated design aids in the transfer of data (communications). Each pair is shown perpendicular to the other.

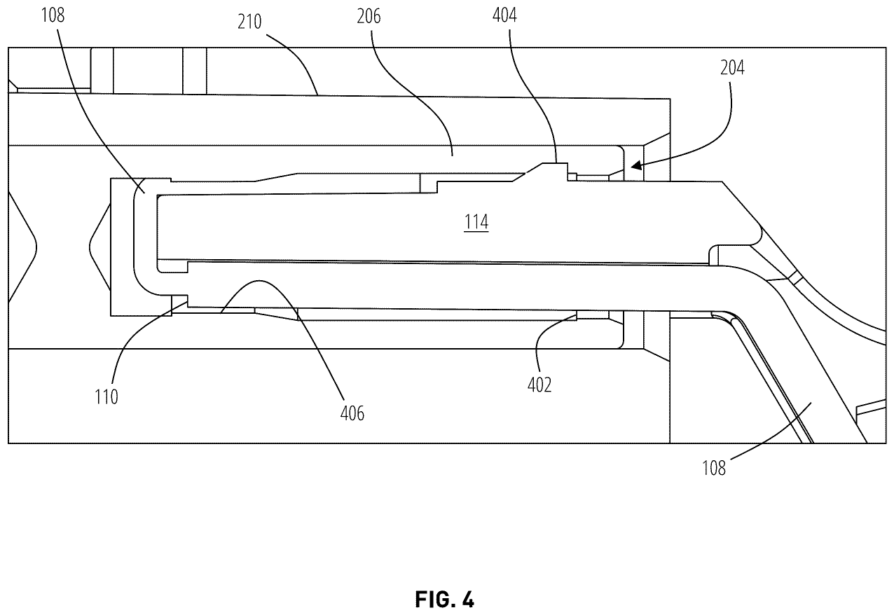

A contact sleeve 206 is inserted into each of the apertures 204 to provide a contact surface for each of the conductors 108 that is a better conductor than the ethernet base 210 in which the apertures 204 are formed. Each contact sleeve 206 is a substantially annular cylinder and is better illustrated in FIG. 4. The ethernet base 210 and contact sleeves 206 are formed as a single body. The contact sleeves 206 may include a plated copper alloy and are overmolded with PEEK.

Four additional power connectors 208 extend from the connector 202 within the recessed space 214. These power connectors 208 may be used to facilitate a power connection, or any other desired connection.

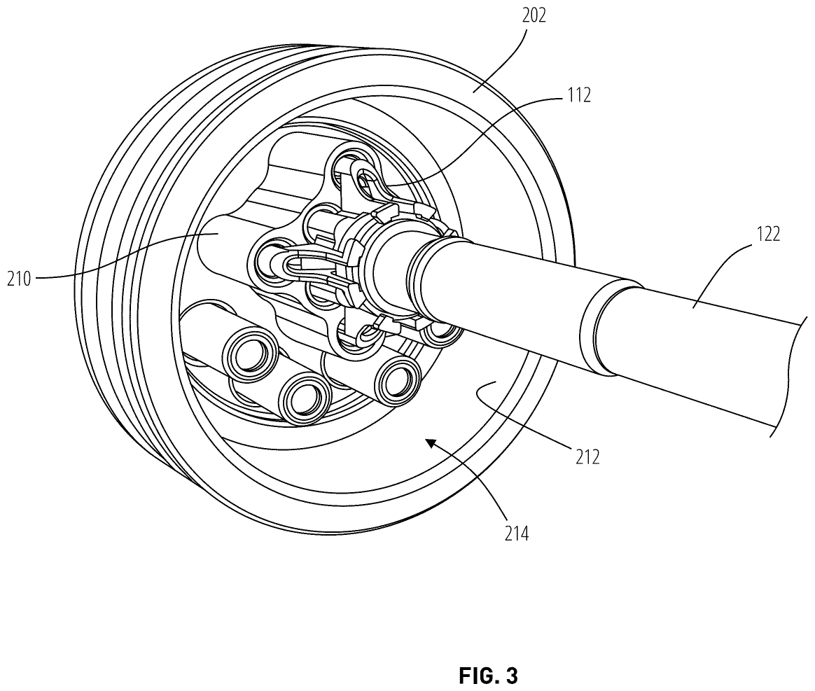

FIG. 3 illustrates the termination after the wire cage 112 is inserted into the connector 202. In this arrangement, each arm 114 is positioned within one of the apertures 204 defined by the ethernet base 210.

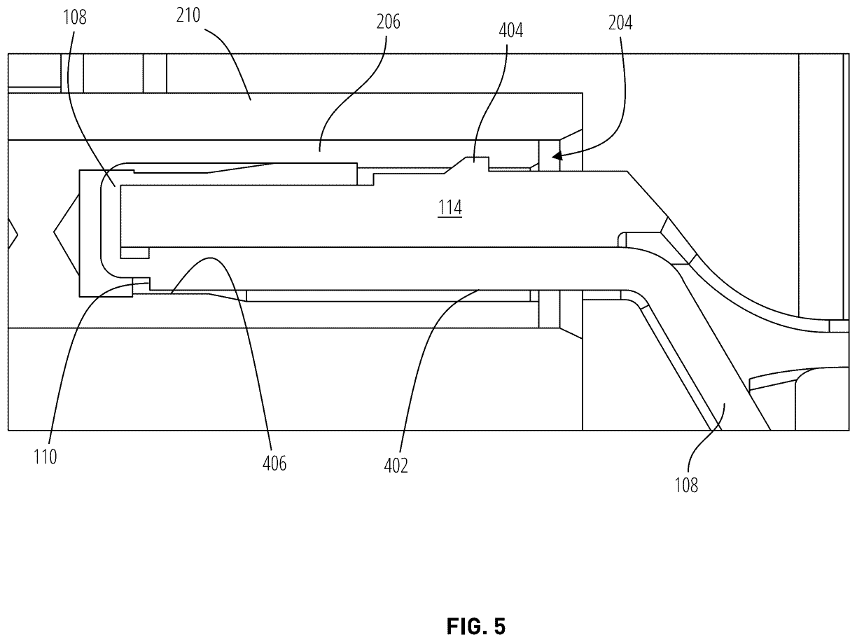

FIG. 4 and FIG. 5 are cross-sectional views of the arrangement illustrated in FIG. 3. As illustrated, the contact sleeve 206 is inserted into the aperture 204 and includes an interior bore sized to receive the arm 114 and its associated conductor 108. The contact sleeve 206 includes an undercut 402 arranged to engage a latch member 404 formed as part of each arm 114. The engagement of the undercut 402 and the latch member 404 aids in retaining the wire cage 112 in the connector 202.

Each contact sleeve 206 also includes a reduced diameter portion 406 that is sized to engage the conductor 108 to tightly compress the conductor 108 against the contact sleeve 206 to form an electrical connection. The arms 114 will each elastically deflect on entry until removed from contact sleeve 206, analogies to a cantilever.

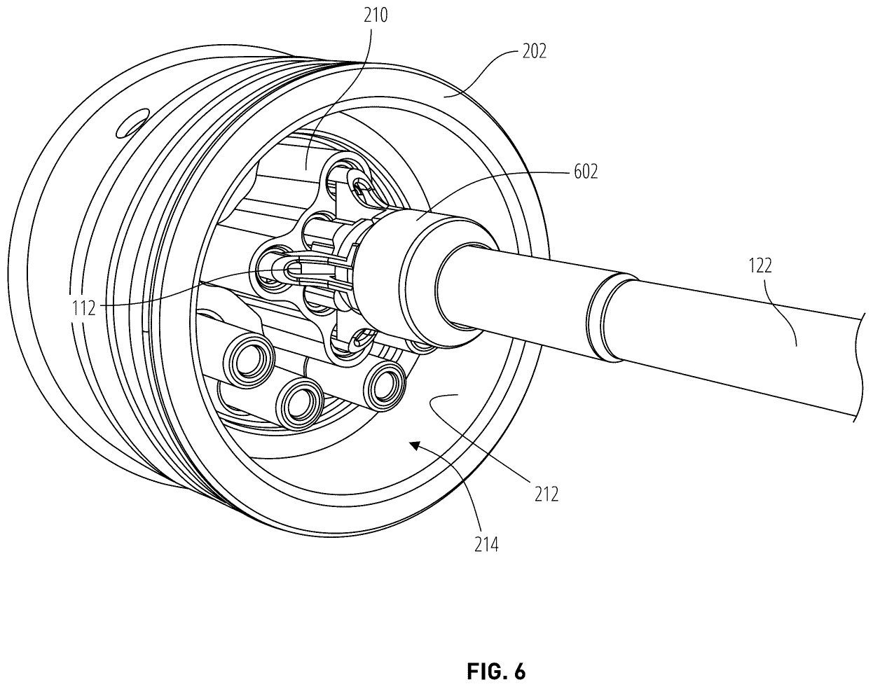

As illustrated in FIG. 6, a support wedge 602 is positioned outside of the cable cover 106 in the area where the wire cage 112 engages the stuffing sleeve 104 as well as the area where the stuffing sleeve 104 is inserted under the cable cover 106. In this position, the support wedge 602 transfers compression onto the cable cover 106 to enhance retention of the stuffing sleeve 104 within the cable cover 106.

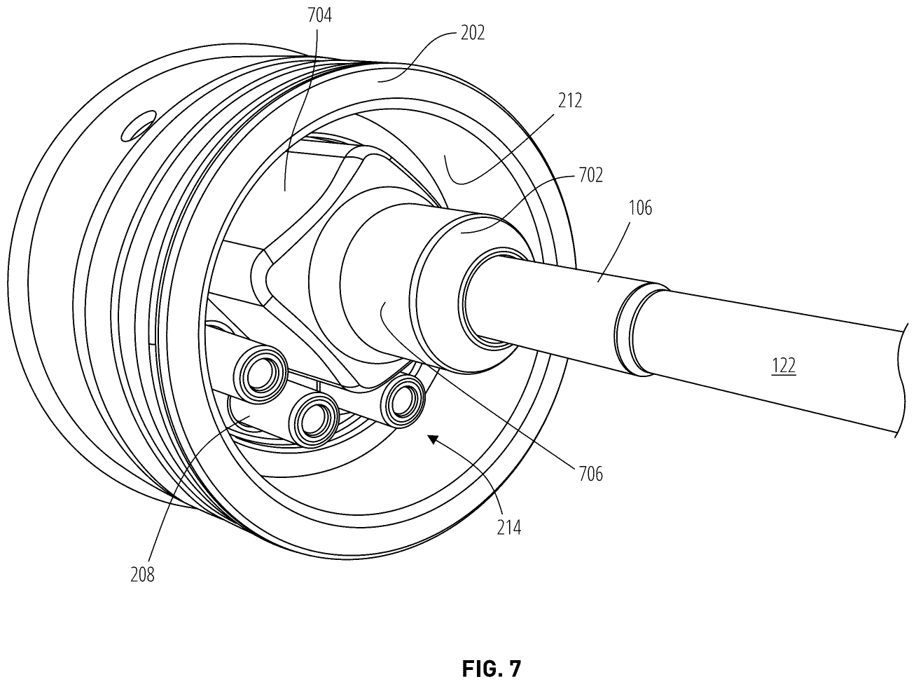

FIG. 7 illustrates the placement of a termination cap 702 over the wire cage 112 and the ethernet base 210. The termination cap 702 includes a base portion 704 and a cable portion 706. The base portion 704 is shaped to generally match the shape of the ethernet base 210 such that when installed, the base portion 704 and the ethernet base 210. The internal profile of the base portion 704 has been sized so that it retains the attachment legs 128 in position when installed. The outer shape of the termination cap 702 is provides a smooth profile for the termination boot 802 to seat against.

The cable portion 706 is generally cylindrical and includes an aperture sized to tightly engage the outer surface of the cable cover 106 and/or the support wedge 602. The support wedge 602 also supports the termination cap 702 when installed. In other constructions, the cable portion 706 may be sized to engage and form a seal against another component such as the wire cage 112.

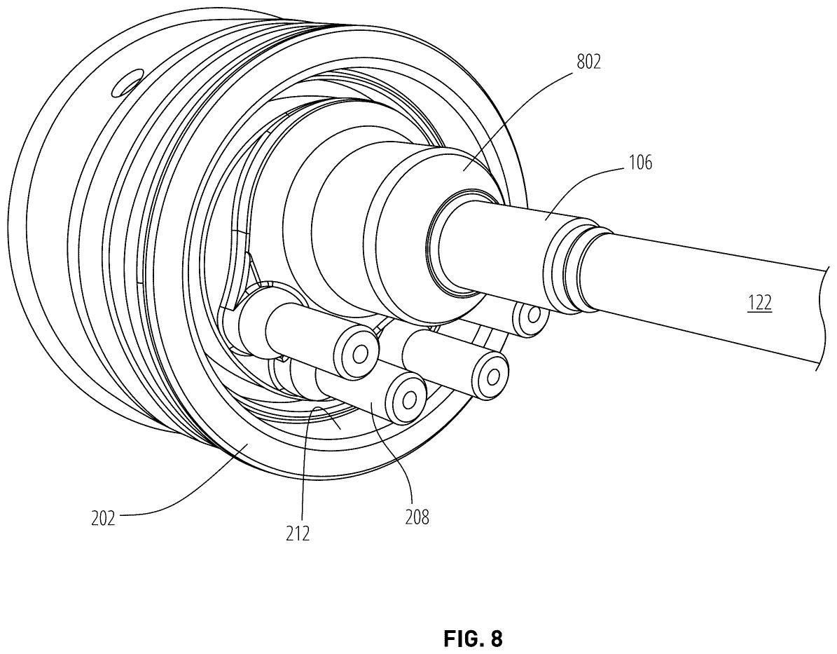

The next component used for the termination of the ethernet cable 122 is a termination boot 802 that is placed over the termination cap 702 as illustrated in FIG. 8. The termination boot 802 is a resilient member, such as an elastomeric material, that covers the termination cap 702 and the power connectors 208. The outer surface of the cable cover 106 contacts the termination boot 802 such that the termination boot 802, the cable cover 106, and the termination cap 702 form a seal therebetween.

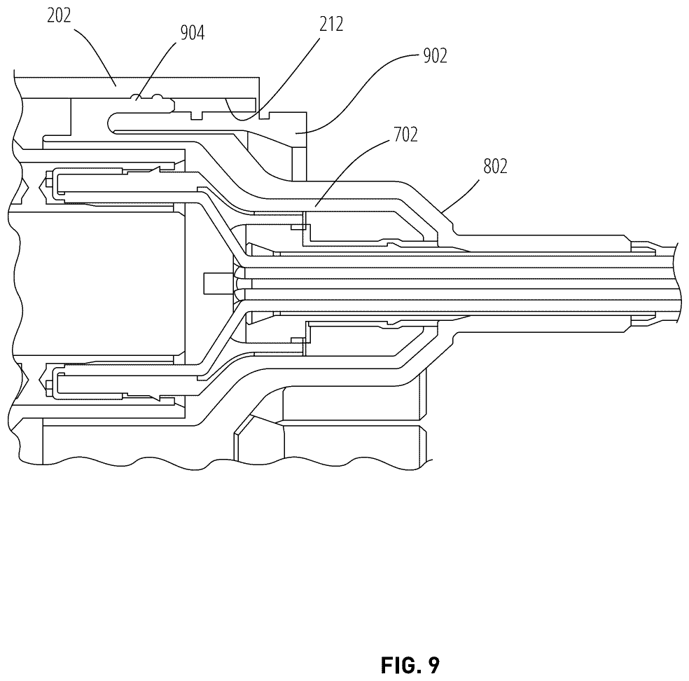

As illustrated in FIG. 9, a compression ring 902 is positioned within the connector 202 and operates to compress the termination boot 802 against the outer wall 212 and against the termination cap 702, thereby forming additional seals between the outside environment and the connection made between each conductor 108 and connector 202. To enhance the seal between the termination boot 802 and the outer wall 212, the termination boot 802 may include one or more ridges 904. The ridges 904 are compressed against the outer wall 212 to form the desired seal.

In some constructions, an outer surface of the connector 202 includes grooves arranged to receive seal members such as O-rings and the like. A metallic cover (not shown) may be fitted over the seal members to cover the termination boot 802, the compression ring 902, and the recessed space 214 to further seal the area. In some constructions, a sealant or other substance is added to the space between the metallic cover and the recessed space 214. An earth ring (not shown) is positioned within the grooves of the compression ring 902 and aids in terminating a cable screen, if required. The earth ring is secured in place when an outer cover (not shown) is installed.

To complete the termination of the cable 102, and in particular the ethernet cable 122, a portion of the cable cover 106 is removed to expose the conductors 108. The stuffing sleeve 104 is then positioned with a portion of the stuffing sleeve 104 positioned under the cable cover 106. Each conductor 108 extends through the wire cage 112 with each conductor 108 passing through an exit aperture 124. A portion of each conductor 108 is stripped to remove the insulation 110 and expose the conductor 108. The conductors 108 are then positioned such that a still insulated portion extends along the second recess 118, a stripped or unstripped portion passes around the arm end 126, and the stripped portion of the conductor 108 passes along the first recess 116.

The wire cage 112 is next inserted into the connector 202 by inserting each arm 114 into one of the contact sleeves 206 disposed in one of the apertures 204. Once positioned, the conductor 108 surrounding each arm 114 contacts the contact sleeve 206 to form a reliable electrical connection.

The support wedge 602 is installed adjacent the wire cage 112 followed by the positioning of the termination cap 702 over the support wedge 602, the wire cage 112, and the ethernet base 210. The termination cap 702 contacts the ethernet base 210 and may contact the cable cover 106 or the wire cage 112.

Next, the termination boot 802 is positioned over the termination cap 702 and the power connectors 208 to form a seal. The termination boot 802, as illustrated in FIG. 9 contacts the cable cover 106, the termination cap 702, and the power connectors 208 to form the desired seals.

The compression ring 902 is positioned within the termination boot 802 to compress it against the outer wall 212 of the connector 202. The compression ring 902 pushes the termination boot 802 into sealing contact with the outer wall 212 of the connector 202 to enhance the sealing.

Thus, the illustrated construction facilitates the termination of the ethernet cable 122 without any special tools and little to no special skills, thereby reducing the cost and the lead time to terminate such cables 102. Specifically, the termination described herein does not require soldering or any subsequent NDT (nondestructive testing) such as CT (computed tomography) testing on terminated joints, leading to a considerable reduction in assembly time and costs, including third party testing. In addition, the termination allows the disassembly of all components without causing damage and removes complexities and specialist training required to assemble the termination. The arrangement also allows for re-use of products and reduces overall waste. In addition, no specialist tools such as crimp/swage tooling or machinery are required to perform the assembly and there is no requirement for a potting solution to provide strain relief. Thus, the arrangement discussed herein allows for the use of an ethernet cable 122 that was not originally intended for subsea use to be used in a subsea or marine application.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A termination system comprising:
a cable including a first quantity of conductors;
a wire cage coupled to the cable and including a second quantity of arms arranged in a first pattern, the second quantity equal to the first quantity, each arm including a first recess that extends to an end of the arm, a portion of one of the first quantity of conductors positioned within the first recess;
a connector including a third quantity of apertures arranged in a second pattern that corresponds to the first pattern;
a plurality of contact sleeves, each contact sleeve disposed within one of the apertures and sized to receive one of the arms, the conductor associated with the arm in electrical contact with the contact sleeve; and
a termination cap coupled to the cable.

2. The termination system of claim 1, wherein the cable is an ethernet cable and wherein the first quantity, the second quantity, and the third quantity each equal eight.

3. The termination system of claim 1, wherein each arm includes a latch member that engages the associated contact sleeve to retain the arm within the contact sleeve.

4. The termination system of claim 1, wherein each arm includes a second recess opposite the first recess, and wherein a portion of the conductor is disposed within each of the first recess and the second recess.

5. The termination system of claim 4, wherein each contact sleeve includes a reduced diameter portion arranged to engage the portion of the conductor in each of the first recess and the second recess.

6. The termination system of claim 1, further comprising a termination boot positioned to cover the termination cap and form a high-pressure seal against the cable.

7. The termination system of claim 1, wherein the connector includes an annular outer wall, and wherein a compression ring is positioned over the termination boot between the termination cap and the outer wall, the compression ring compressing the termination boot against the outer wall.

8. The termination system of claim 1, wherein each of the arms extends parallel to a long axis of the wire cage.

9. A termination system comprising:
an ethernet cable including eight conductors;
a wire cage coupled to the ethernet cable and including eight arms arranged in a pattern, each arm including a first recess that extends to an end of the arm, each conductor associated with one of the arms and including a portion positioned within the first recess;
a connector including eight apertures arranged in the pattern;
eight contact sleeves, each contact sleeve disposed within one of the apertures and sized to receive one of the arms, the conductor associated with the arm in electrical contact with the contact sleeve; and
a termination cap coupled to the cable.

10. The termination system of claim 9, wherein the contact sleeves are arranged orthogonally to match the pattern of the arms.

11. The termination system of claim 9, wherein the cable is an ethernet cable and wherein the first quantity, the second quantity, and the third quantity each equal eight.

12. The termination system of claim 9, wherein each arm includes a latch member that engages the associated contact sleeve to retain the arm within the contact sleeve.

13. The termination system of claim 9, wherein each arm includes a second recess opposite the first recess, and wherein a portion of the conductor is disposed within each of the first recess and the second recess.

14. The termination system of claim 13, wherein each contact sleeve includes a reduced diameter portion arranged to engage the portion of the conductor in each of the first recess and the second recess.

15. The termination system of claim 9, further comprising a termination boot positioned to cover the termination cap and form a high-pressure seal against the cable.

16. The termination system of claim 9, wherein the connector includes an annular outer wall, and wherein a compression ring is positioned over the termination boot between the termination cap and the outer wall, the compression ring compressing the termination boot against the outer wall.

17. The termination system of claim 9, wherein each of the arms extends parallel to a longitudinal axis of the wire cage.

18. A method of terminating an ethernet cable, the method comprising:
connecting a wire cage to the ethernet cable, the wire cage including eight arms that extend parallel to one another along a long axis;
extending each of eight conductors along one and only one of the arms in a direction parallel to the long axis along a first side and a second side opposite the first side;
positioning each of eight contact sleeves in an aperture formed in a connector;
inserting each of the arms into one of the contact sleeves such that the corresponding conductor of each arm forms an electrical connection with the corresponding contact sleeve; and
positioning a termination cap to cover the wire cage.

19. The method of claim 18, further comprising forming a first recess on the first side of each arm and a second recess on the second side of each arm.

20. The method of claim 18, positioning a termination boot to cover the termination cap and form a high-pressure seal against the cable.

21. The method of claim 18, inserting a compression ring over the termination boot between the termination cap and an outer wall of the socket connector, and compressing the termination boot against the outer wall.
